(19) United States
(12) Patent Application Publication
(10) Pub. No.: US 2025/0132984 A1
(43) Pub. Date: Apr. 24, 2025

(54) TRAFFIC PREDICTION METHOD FOR METROPOLITAN OPTICAL NETWORK AND RELATED DEVICE

(71) Applicant: Beijing University of Posts and Telecommunications, Beijing (CN)

(72) Inventors: Hui YANG, Beijing (CN); Yunyu ZHANG, Beijing (CN); Qiuyan YAO, Beijing (CN); Tiankuo YU, Beijing (CN); Jie ZHANG, Beijing (CN)

(73) Assignee: Beijing University of Posts and Telecommunications, Beijing (CN)

(21) Appl. No.: 18/824,150

(22) Filed: Sep. 4, 2024

(30) Foreign Application Priority Data
Oct. 19, 2023 (CN) 202311359623.3

(51) Int. Cl. H04L 41/147; H04Q 11/00

(52) U.S. Cl. CPC H04L 41/147; H04Q 11/0062; H04Q 2011/0083

(57) ABSTRACT

Disclosed are a traffic prediction method for a metropolitan optical network and related devices. The traffic prediction method may include: classifying nodes in the metropolitan optical network into multiple node sets based on locations of the nodes; for nodes in each node set, inputting temporal traffic data of the nodes into a traffic prediction model corresponding to the node set to obtain traffic prediction results of the nodes in the node set. In the method, the traffic prediction model is obtained by deep learning using historical time-series traffic data of the node sets as a training set.

### CROSS-REFERENCE TO RELATED APPLICATIONS

This application claims priority to Chinese Patent Application No. 202311359623.3, filed on Oct. 19, 2023, the content of which is incorporated herein by reference in its entirety.

### TECHNICAL FIELD

The present disclosure relates to communication technology, and in particular to a traffic prediction method for a metropolitan optical network and related devices.

### BACKGROUND

As a network load of each node in a metropolitan optical network varies with the number of devices connected, tidal phenomena of network loads in the metropolitan optical network would occur, as people's gathering locations change with time throughout a day.

In order to schedule nodes reasonably and prevent service congestions, it is necessary to predict traffic of nodes in the metropolitan optical network accurately. However, in related technologies, allocations of network resources are static. Moreover, traffic of nodes is predicted by taking nodes as a whole without taking into account the tidal phenomena which may lead to different traffic patterns among nodes in different regions. In this case, the accuracy of traffic prediction of nodes in the metropolitan optical network may be low.

### SUMMARY

Examples of the present disclosure provide a traffic prediction method for a metropolitan optical network and related devices.

In examples of the present disclosure, the traffic prediction method for a metropolitan optical network may include: classifying nodes in the metropolitan optical network into multiple node sets based on locations of the nodes; for nodes in each node set, inputting temporal traffic data of the nodes into a traffic prediction model corresponding to the node set to obtain traffic prediction results of the nodes in the node set; where, the traffic prediction model is obtained by a deep learning using historical time-series traffic data of the node set as a training set.

In examples of the present disclosure, classifying nodes in the metropolitan optical network into multiple node sets based on locations of the nodes may include: obtaining bandwidth demand data of the nodes in the metropolitan optical network; classifying the nodes into at least two types based on the bandwidth demand data of the nodes; grouping adjacent nodes of a same type into a node set to obtain the multiple node sets.

In examples of the present disclosure, the historical time-series traffic data of the node set is obtained through the following steps: obtaining the bandwidth demand data of nodes included in the node set; segmenting the bandwidth demand data according to a preset time interval to obtain bandwidth demand data of multiple time periods; processing the bandwidth demand data of the multiple time periods to obtain multiple rate data; and storing the multiple rate data and corresponding time periods to obtain the historical time-series traffic data.

In examples of the present disclosure, the rate data include: an average rate, a maximum rate, a minimum rate, a first quartile rate, a second quartile rate, and a third quartile rate.

In examples of the present disclosure, a neural network used for the deep learning include any of a recurrent neural network, a bidirectional recurrent neural network, a long short-term memory network, and a bidirectional long short-term memory recurrent network.

In examples of the present disclosure, after obtaining the traffic prediction results of the nodes, the method may further include: determining bandwidth of the nodes based on the traffic prediction results of the nodes.

In examples of the present disclosure, after determining the bandwidth of the nodes, the method may further include: determining a target node for data transmission with a source node; and determining a modulation format for data transmission based on a distance between the source node and the target node, as well as the bandwidth of the source node.

Examples of the present disclosure also provide a traffic prediction device for a metropolitan optical network. The traffic prediction device for a metropolitan optical network may include: a node classifying module, to classify nodes in the metropolitan optical network into multiple node sets based on locations of the nodes; and a traffic prediction module, for nodes in each node set, to input temporal traffic data of the nodes into a traffic prediction model corresponding to the node set to obtain traffic prediction results of the nodes in the node set; where, the traffic prediction model is obtained by a deep learning using historical time-series traffic data of the node set as a training set.

Examples of the present disclosure also provide an electronic device, which includes: a memory, a processor, and a computer program stored in the memory and executable on the processor. The processor executes the program to implement the traffic prediction method described above.

Examples of the present disclosure also provide a non-transient computer-readable storage medium which stores computer instructions for causing a computer to execute the traffic prediction method described above.

From the above, it can be seen that the traffic prediction method for a metropolitan optical network and a related device provided in the present disclosure may classify nodes in the metropolitan optical network according to their locations. In this case, nodes with similar tidal phenomena can be grouped into a same node set. Moreover, a traffic prediction model can be established for each node set, which may fully consider the tidal phenomena that causes different traffic changes in nodes in different regions. The traffic prediction method and related device may improve pertinence, and achieve a high prediction accuracy.

### BRIEF DESCRIPTION OF THE DRAWINGS

In order to describe technical solutions of the present application or related arts more clearly, accompanying drawings required for describing examples or the related art are introduced briefly in the following. Apparently, the accompanying drawings in the following descriptions only illustrate some examples of the present application, and those of ordinary skill in the art may still derive other drawings from these drawings without creative efforts.

FIG. 1 is a schematic diagram of a traffic prediction method for a metropolitan optical network according to examples of the present disclosure.

FIG. 2 is a schematic diagram of a structure of a metropolitan optical network which adopts the traffic prediction method according to examples of the present disclosure.

FIG. 3 is a schematic diagram illustrating a process of establishing a traffic prediction model and conducting traffic predictions according to examples of the present disclosure.

FIG. 4 is a schematic diagram illustrating a process for determining a modulation format for data transmission according to examples of the present disclosure.

FIG. 5 is a schematic diagram illustrating a process of resource allocations based on traffic prediction results according to examples of the present disclosure.

FIG. 6 is a schematic diagram illustrating a structure of a traffic prediction device for a metropolitan optical network according to examples of the present disclosure.

FIG. 7 is a schematic diagram illustrating a structure of an electronic device according to examples of the present disclosure.

### DETAILED DESCRIPTION OF THE EMBODIMENTS

Hereinafter, in order to make the objective(s), technical solution(s) and advantages of the present application clearer and more understandable, the present application will be further described in detail, in connection with specific embodiments and with reference to the accompanying drawings.

It is necessary to be noted that the technical terms or scientific terms used in the embodiments of the present application should have common meanings as understood by those skilled in the art of the present application, unless otherwise defined. The “first”, “second” and similar words used in the embodiments of the present application do not refer to any sequence, number or importance, but are only used to distinguish different component portions. The “comprise”, “include” or a similar word means that an element or item before such word covers an element or item or any equivalent thereof as listed after such word, without excluding other elements or items. The “connect” or “interconnect” or a similar word does not mean being limited to a physical or mechanical connection, but may include a direct or indirect electrical connection. The “upper”, “lower”, “left” and “right” are used only to indicate a relative position relation, and after the absolute position of the described object is changed, the relative position relation may be changed accordingly.

Metropolitan optical network is an important component of optical networks. With a development of metropolitan area networks and a gradual expansion of city sizes, more and more service requests (requests for short) need to be processed and transmitted. The daily movements of a large population in urban areas are highly predictable and exhibit a repetitive pattern of temporal changes. Specifically, according to commuting needs of users, they concentrate in working areas during commuting and in living areas during other times. The network load of the metropolitan optical network system changes periodically over time, similar to a tidal phenomenon. Due to the presence of the tidal phenomena, network nodes may experience peaks in requests at certain times, bringing enormous operational pressure. However, traditional network resource allocation methods are static. Moreover, operators find it difficult to schedule link resources reasonably to cope with short-term tidal traffic changes, resulting in a large number of services being blocked. Or predict all nodes as a whole based on historical data, without considering the tidal phenomenon that leads to different flow patterns of nodes in different regions.

Therefore, the accuracy of traffic prediction is low. Based on the above-mentioned deficiencies, examples of the present disclosure provide a traffic prediction method for a metropolitan optical network and a related device. The traffic prediction method for a metropolitan optical network and the related device provided in the present disclosure may classify nodes in the metropolitan optical network according to their locations. In this case, nodes with similar tidal phenomena can be grouped into a same node set. Moreover, a traffic prediction model can be established for each node set, which may fully consider the tidal phenomena that causes different traffic changes in nodes in different regions. The traffic prediction method and the related device may improve pertinence, and achieve a high prediction accuracy.

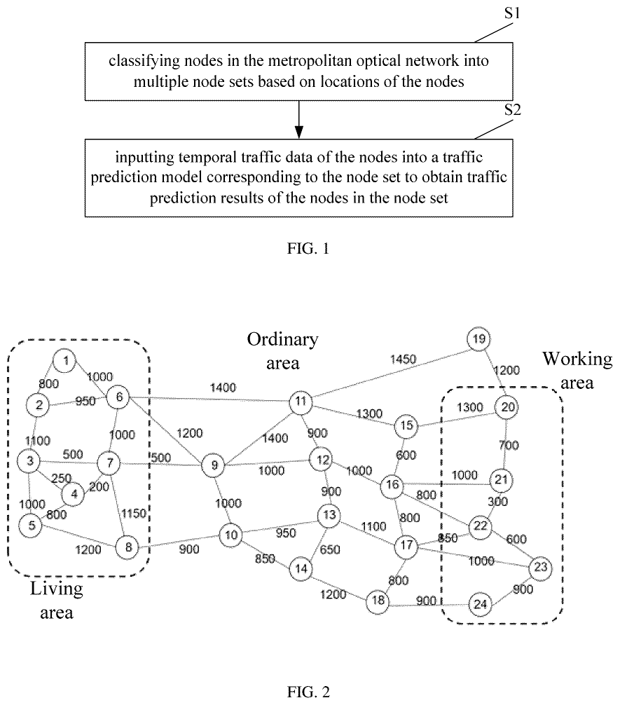

FIG. 1 is a schematic diagram of a traffic prediction method for a metropolitan optical network according to examples of the present disclosure. FIG. 2 is a schematic diagram of a structure of a metropolitan optical network which adopts the traffic prediction method according to examples of the present disclosure.

As shown in FIG. 1 and FIG. 2, the traffic prediction method for a metropolitan optical network may include the following steps.

In step S1, classifying nodes in the metropolitan optical network into multiple node sets based on locations of the nodes.

In examples of the present disclosure, in order to distinguish nodes with different tidal phenomena (such as different peak occurrence times and different valley occurrence times), nodes are classified and grouped into multiple node sets. Because adjacent nodes usually have the same tidal phenomenon, the region where the nodes are located or locations of the nodes can be used as a criterion for the classification.

In examples of the present disclosure, the step S1 may include the following steps.

At first, obtaining bandwidth demand data of the nodes in the metropolitan optical network.

Then, classifying the nodes into at least two types based on the bandwidth demand data of the nodes.

At last, grouping adjacent nodes of a same type into a node set to obtain the multiple node sets.

In examples of the present disclosure, the bandwidth demand data can be used to determine the traffic passing through the nodes during a certain time period. In this way, relationships between traffic of the nodes and time periods of the day can be determined, and the tidal phenomenon of traffic of the nodes can be determined and judged. Therefore, the classification of the nodes can be determined. For example, referring to FIG. 2, the nodes can be divided into three categories: working area nodes, living area nodes, and ordinary area nodes. The working area nodes may be located in central areas of a city. During weekdays, users access networks in a large number, especially during peak hours, generating large amount of traffic data. During non-peak hours, especially in the evening or at night, network traffic decreases and resources become idle. On non-working days, network traffic is much less than that on working days. The living area nodes may be located in edge areas of a city, with fewer users during morning and evening peak hours on weekdays, and the load pressure on network devices is relatively lighter. During non-peak hours, especially in the evening and at night, traffic increases and resources are scarce. The nodes where tidal phenomena are not obvious, that is, nodes outside the working area and living area nodes, are ordinary area nodes.

In examples of the present disclosure, adjacent similar nodes may be grouped into a node set. In other words, similar nodes with a long distance may belong to different node sets. In specific implementations, it can be determined whether two nodes of a same class are adjacent based on the distance between these two nodes. That is, when the distance between two nodes of a same class is less than a preset distance threshold, it can be judged that the two nodes are adjacent similar nodes. When forming the node sets, two adjacent similar nodes may be grouped into a node set. Then, it is determined whether the remaining nodes of the same class are adjacent to the nodes in the node set. If they are determined to be adjacent nodes (that is, the distance between the two nodes is less than the preset distance threshold), they can be added to the node set until there are no nodes of the same class that can join the node set. In this way, a node set can be established.

In step S2, for nodes in each node set, inputting temporal traffic data of the nodes into a traffic prediction model corresponding to the node set to obtain traffic prediction results of the nodes in the node set.

In examples of the present disclosure, each node set may correspond a traffic prediction model. The traffic prediction model corresponding to a node set may be obtained by a deep learning using historical time-series traffic data of the node set as a training set.

In examples of the present disclosure, the nodes in each node set may have similar tidal phenomena. Therefore, a traffic prediction model can be established for each node set to predict the traffic of all nodes included in the node set. In this way, there is no need to establish a traffic prediction model for each node. Thus, prediction costs can be significantly reduced. The method is more suitable for metropolitan optical networks with multiple nodes in each region.

In examples of the present disclosure, the historical time-series traffic data of the node sets may be obtained through the following steps.

At first, obtaining the bandwidth demand data of nodes included in a node set.

In examples of the present disclosure, the bandwidth demand data of all nodes in the node set over a period of historical time can be obtained and used. For example, the bandwidth demand data of the nodes in one year can be used.

Then, segmenting the bandwidth demand data according to a preset time interval to obtain bandwidth demand data of multiple time periods.

In examples of the present disclosure, the bandwidth demand data of a time period can be obtained through segmentation to determine the relationships between bandwidth demand data and time periods.

Further, processing the bandwidth demand data of the multiple time periods to obtain multiple rate data.

In examples of the present disclosure, for each time period, the bandwidth demand data for the time period can be processed to obtain the rate data of the time period.

At last, storing the multiple rate data and corresponding time periods to obtain the historical time-series traffic data.

In examples of the present disclosure, the historical time-series traffic data of a node set can be used as a dataset for establishing the traffic prediction model corresponding to the node set, which needs to include traffic information and corresponding time information. Therefore, storing the rate data as the traffic information and storing the time periods as the time information can obtain the historical time-series traffic data.

In examples of the present disclosure, the rate data may include: an average rate, a maximum rate, a minimum rate, a first quartile rate, a second quartile rate, and a third quartile rate.

The feature dimensions of a model are related to the feature dimensions of a training set. Therefore, in order to increase the feature dimensions of the model, types of the data of the training set should be enriched to improve a training effect of the model. In examples of the present disclosure, during data processing, the average rate, the maximum rate, the minimum rate, the first quartile rate, the second quartile rate, and the third quartile rate of a time period can all be generated based on the bandwidth demand data of the time period.

In examples of the present disclosure, a neural network used for the deep learning may include any of a recurrent neural network, a bidirectional recurrent neural network, a long short-term memory network, and a bidirectional long short-term memory recurrent network.

To be noted, deep learning neural networks can be used to establish the traffic prediction models, which are not limited to recurrent neural networks, bidirectional recurrent neural networks, long short-term memory networks, and bidirectional long short-term memory recurrent networks. FIG. 3 shows a process of establishing a traffic prediction model and conducting traffic predictions according to examples of the present disclosure. Referring to FIG. 3, when the neural network used to construct the traffic prediction model is a bidirectional long short-term memory recurrent network (BiLSTM), the model can be constructed based on the BiLSTM principle, with input features, hidden layers, and output layers set. BiLSTM is a fusion of forward LSTM and backward LSTM, used to extract temporal features in two directions and capture temporal dependencies between the two directions. Input the same sequence into two LSTMs, one forward and one backward, considering a past feature and a future feature of the flow simultaneously. Then, the outputs of both LSTMs are concatenated with certain weights to obtain a final result.

In examples of the present disclosure, a hidden state hr of the forward layer and a hidden state h_{b} of the backward layer can be initialized as the following.

h_{f}=O_{f}*tanh(C_{f})

h_{b}=O_{b}*tanh(C_{b})

The final hidden state can be concatenated as H=(h_{f}, h_{b}), which is a combination of a forward result and a backward result. H is used to calculate a final output. Optimal parameters can be determined based on changes in the loss function by choosing different learning rates, hidden layer layers, number of hidden layer neurons, and iteration times. Specifically, the learning rate is generally between 0.0001-0.01. The number of hidden layers is 1-5. For simple one-dimensional time-series traffic data, it can be set to 1 layer. The number of hidden layer neurons is usually taken as a N^{th} power of 2.

The bidirectional long short-term memory recurrent network is set up with two LSTM networks, forward and backward. Due to the periodicity of tides, there will be repeated changes in the morning and evening peaks. The temporal dependence of forward and backward traffic data helps to improve prediction performance. Using a bidirectional long short-term memory recurrent network for traffic prediction can explore the bidirectional relationship between traffic days and fully extract the overall characteristics of optical network traffic.

In examples of the present disclosure, after obtaining the traffic prediction results of the nodes, the method may further include: determining bandwidth of the nodes based on the traffic prediction results of the nodes.

In examples of the present disclosure, the bandwidth may be set based on the traffic prediction results to meet the network demand for a period of time in the future, and to prevent resource idle waste caused by excessive bandwidth.

In specific implementation, when determining the bandwidth, the traffic prediction results can be assigned as a predicted time series to matrix variables and imported into the algorithm to obtain the bandwidth. At the same time, other network parameter values can be initialized, including node and link information of the topology graph used, maximum frequency gap, total number of requests, transmission distance threshold, protection bandwidth, traffic load, etc. Where, each parameter is set according to specific application scenarios, and the traffic load determines the start time of requests. The more load there is, the earlier the start time of requests, and the more requests are generated per unit time.

In examples of the present disclosure, after determining the bandwidth of the nodes, the method may further include: determining a target node for data transmission with a source node; and determining a modulation format for data transmission based on a distance between the source node and the target node, as well as the bandwidth of the source node. That is, when a service request from a source node to a target node is received, a modulation format for data transmission can be determined based on a distance between the source node and the target node as well as a bandwidth request of the service request. Specifically, the modulation format for data transmission can be determined by the following method. At first, a shortest path from the source node to the destination node may be determined, such as by the K-shortest path algorithm. Then, a transmission distance of the shortest path may be determined. Further, an optimal modulation format may be selected according to the transmission distance of the shortest path based on relationships between transmission distance ranges and modulation levels. At last, required number of frequency slots for the service request may be calculated according to the optimal modulation format and the bandwidth request of the service request.

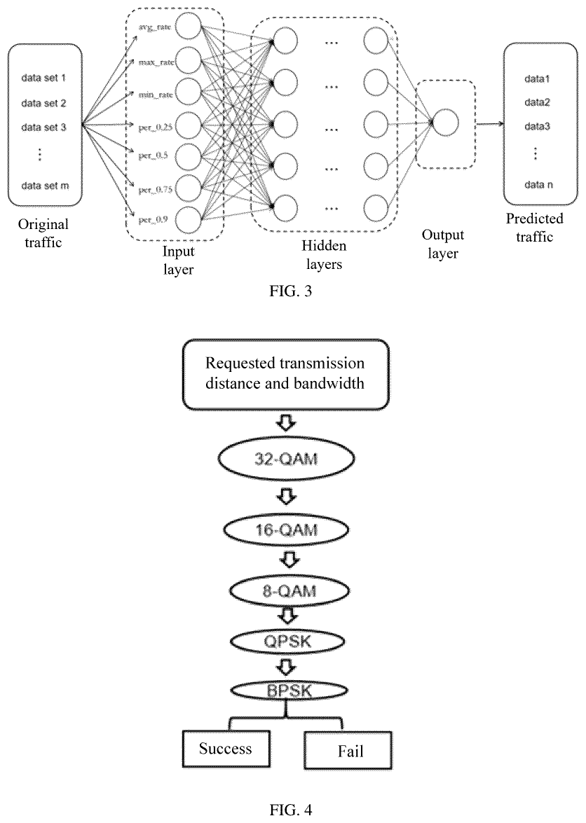

In examples of the present disclosure, after determining the target node, the K-shortest path algorithm can be used to obtain K shortest paths from the source node to the target node, determine the link numbers passed through the paths, and determine the transmission distance of each path. FIG. 4 shows the process of determining the modulation format for data transmission according to examples of the present disclosure. Referring to FIG. 4, the optimal modulation format within the transmission distance threshold can be selected based on the relationships between a transmission distance range and a highest modulation level. The optional modulation formats may be 32-QAM, 16-QAM, 8-QAM, QPSK, and BPSK, with gradually decreasing levels. The higher the modulation level, the less frequency gap resources are occupied, and the shorter the transmission distance can be. Specifically, selecting 32-QAM, 16-QAM, 8-QAM, and QPSK can reduce the frequency gap resources required by 4/5, 3/4, 2/3, and 1/2 compared to BPSK. For each additional modulation level, the maximum transmission distance of the service request is correspondingly reduced to half. Calculate the required number of frequency slots based on the ratio of bandwidth to the capacity of a single frequency slot. Using the first matching spectrum allocation algorithm, search for available frequency slot resources that meet the requirements from the minimum number of frequency slots. Once a frequency slot block that meets the requirements appears, it is directly allocated to the service request, and the current request is successfully processed.

In this way, by dynamically adjusting the modulation level of the request, short-range services can prioritize higher modulation levels, reduce the number of encoding bits, and achieve transmission with fewer frequency gap resources. Moreover, for long-distance services, lower modulation levels can be chosen to meet service quality requirements, reduce the utilization of bandgap resources and lower the likelihood of spectrum fragmentation.

The traffic prediction method of the present disclosure will be further explained in conjunction with an example of a metropolitan optical network.

Step 1: determining ranges of living areas and working areas in the metropolitan optical network.

Regarding the topology structure in the system architecture diagram, due to the presence of the tidal phenomena, the area where nodes 1 to 8 are located is set as the “living area”, and nodes 20 to 24 are set as the “working area”. A living area refers to a geographical range covered by individuals in their daily lives. The network traffic in this area shows a trend of increasing to the highest peak during off work hours and gradually decreasing to the lowest valley during working hours. A working area can refer to a geographical area covered by an individual in their daily professional activities, where network traffic shows a trend of reaching its peak in working hours and gradually decreasing to its lowest valley during off hours.

Step 2: data collection and preprocessing.

At first, a node in a working area may be selected as a source node for requests. Then, the bandwidth demand data of the source node may be obtained. Resampling processes are performed at 10 minute intervals and network traffic rates of the node are calculated in every ten minutes. In order to increase the feature dimension of the model and enrich data types, the average rate, the maximum rate, the minimum rate, the first quartile rate, the second quartile rate, and the third quartile rate within the time period may be generated. Our goal is to predict (tn+1, tn+2, . . . , tn+m) based on samples of a historical time series (t1, t2, . . . , tn). Where, m=1,2,3, . . . . The dataset consists data of 365 days from Jan. 1, 2021 to Dec. 31, 2021. For data in each day, it is divided into 24 groups representing the 24 hours of the day, and each hour is further divided into 10 minute intervals. Therefore, the total number of data set is 365×24×6=52560. The effect after adjusting the dataset is shown in Table 1 below.

TABLE 1

| p_date | p_hourmin | direction | avg_rate | max_rate | min_rate | per_0.25 | per_0.5 | per_0.75 |
|---|---|---|---|---|---|---|---|---|
| 20210101 | 0:00 | Out | 43.29 | 48.75 | 37.33 | 42.13 | 43.56 | 44.58 |

Where, p_date corresponds to a date; p_hourmin corresponds to a time point; direction refers to a direction of traffic, in a format of in or out. Each p-hourmin has an in and an out, corresponding to a sending status and a receiving status of the node at the time of p-hourmin. The direction out is selected as an available dataset to represent the request issued by the node. The different representations of rate at that moment are avg_rate, max_rate, min_rate, per_0.25, per_0.5 and per_0.75, which correspond to the average rate, the maximum rate, the minimum rate, the first quartile rate, the second quartile rate, and the third quartile rate respectively.

Then the dataset may be divided into a training set and a testing set in an 8:2 ratio. Moreover, initial data may be normalized to (0,1) using the MinMaxScaler function to control the data range during model training.

Step 3: training traffic prediction models based on a bidirectional long short-term memory recurrent network.

Use Python 3.6 to compile the code in the Pytorch framework, create LSTM and linear layers, extract features from the LSTM layer, and make the final prediction from the linear layer. Set the input feature to 6, representing 6 different rates. The number of hidden layer neurons is 128. The output feature is 1. The iteration number epoch is 24, representing the number of hours in a day. Set bidirection=True, indicating the use of BILSTM mode. As the model has two directions, the number of hidden layers is twice that of LSTM.

Optimize model performance by comparing changes in loss function corresponding to different iteration times with different optimization algorithms and learning rates. The loss function can be expressed as the minimum mean square error (MSE) and mean absolute error (MAE) to calculate the degree of closeness between the predicted flow value y̌₁ and the true value yᵢ. After multiple experiments, the Adam optimization algorithm was ultimately chosen with a learning rate set to 0.001.

$$MSE = \frac{1}{n} {\sum }_{i = 1}^{n} {( {y}_{i} - \check{{y}_{1}} )}^{2}$$

$$MAE = \frac{1}{n} {\sum }_{i = 1}^{n} \vert {y}_{i} - \check{{y}_{1}} \vert$$

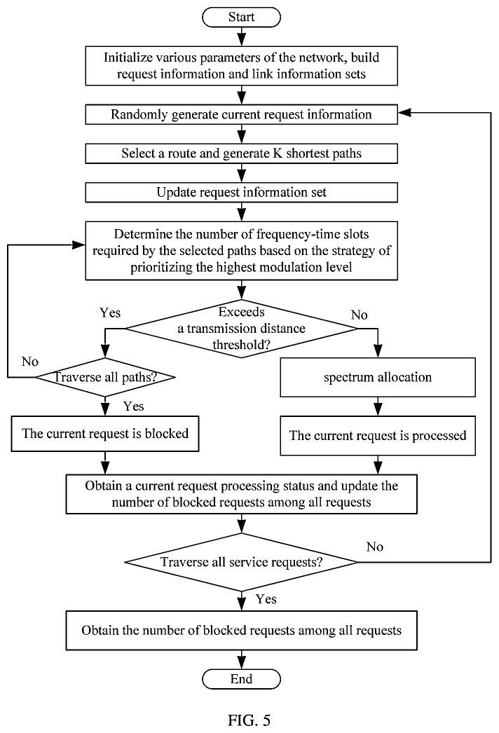

FIG. 5 illustrates a process of resource allocation based on traffic prediction results. Referring to FIG. 5, after obtaining the traffic prediction results, the following steps can also be included.

Step 4: initializing a network topology and request information based on predicting results of the traffic prediction modules.

Initialize various parameters of the network, including node information and link information of the topology graph used, maximum frequency gap number, total number of requests, transmission distance threshold, service bandwidth, protection bandwidth, traffic load, and etc. The number of nodes in the topology structure of the system diagram is 24, and the number of links is 43. The total number of requests is the predicted result number, which is 6824. The bandwidth requirements of each request are determined by the predicted node traffic. The number of protected bandwidth slots is set to 2, and the source nodes of each request are fixed. Assuming node 22, the corresponding destination nodes are randomly generated to generate arrival request information.

Step 5: Determining the number of frequency-time slots required for requests based on the strategy of prioritizing the highest modulation level.

Call a kStortestPath function using the K-shortest path algorithm to obtain K shortest paths from the source node to the destination node, and determine the transmission distance and bandwidth of the current request. Select the optimal modulation format within the transmission distance threshold based on the relationship between transmission distance and modulation level, and calculate the required number of frequency slots for the request.

Taking network nodes {3, 7, 9, 12} as an example, there are three existing services B, C, and D, all of which use node 3 as the source node and transmit to nodes 7, 9, and 12 respectively. The bandwidth requirements are all 12 frequency slot resources. The link distance between 3-7 and 7-9 is 500 km, and the link distance between 9-12 is 1000 km. That is, the shortest transmission distance of service B is 500 km, the shortest transmission distance of service C is 1000 km and the shortest transmission distance of service D is 2000 km. The farthest transmission distance corresponding to the BPSK modulation format is 2000 km. Calculations show that when the modulation format is QPSK, the service can be transmitted for 1000 km. When the modulation format is 8-QAM, the service can transmit 500 km. That is, the relationships between transmission distance ranges and highest modulation format may include: 32-QAM corresponds to a transmission distance less than or equal to 125 km; 16-QAM corresponds to a transmission distance from 125 km to 250 km; 8-QAM corresponds to a transmission distance from 250 km to 500 km; QPSK corresponds to a transmission distance from 500 km to 1000 km; and BPSK corresponds to a transmission distance from 1000 km to 2000 km. Requests will choose higher-level modulation formats as much as possible to reduce the consumption of frequency gap resources while meeting the conditions of the farthest transmission distance. The transmission distance of service B from 3 to 7 is 500 km, and the highest modulation level that can be selected corresponds to 8-QAM modulation mode, requiring 4 frequency slots; The transmission distance of service C from 3 to 9 is 1000 km, and the highest modulation level that can be selected corresponds to QPSK modulation mode, requiring 6 frequency slots; The transmission distance of service D from 3 to 12 is 2000 km, and only BPSK modulation can be selected, requiring 12 frequency slots. In summary, compared to the fixed modulation level of BPSK to ensure the transmission of services in the worst-case scenario, the highest modulation level priority strategy can reduce 14 frequency slot resources, greatly reducing the utilization of frequency slot resources and reducing the possibility of spectrum fragmentation.

Step 6: performing a first matching of spectrum resource allocation.

Starting from the minimum number of frequency slots, search for available frequency slot resources that meet the requirements. Once a frequency slot block that meets the frequency slot requirements appears, it will be directly allocated to the service request, and the current request will be successfully processed; If there are no frequency slot blocks that meet the frequency slot requirements, the current request is blocked, return to step 4, and start processing the next request.

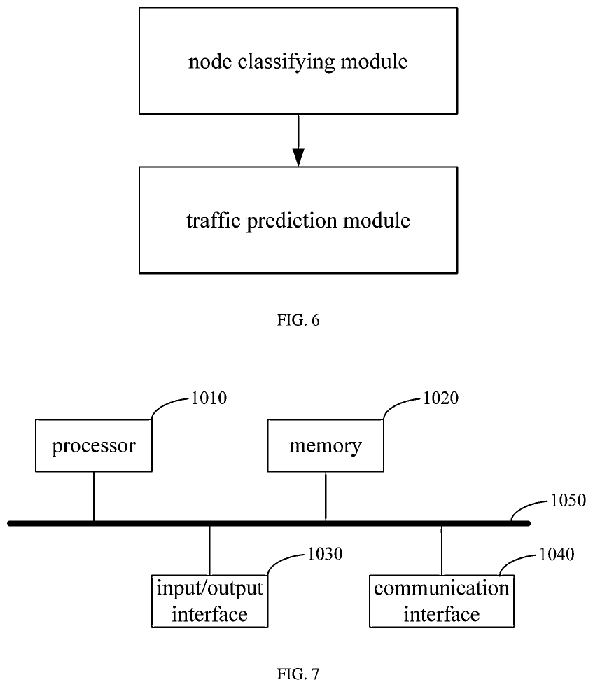

FIG. 6 shows the structure of the traffic prediction device in the metropolitan optical network. Referring to FIG. 6, the present disclosure also provides a traffic prediction device for a metropolitan optical network system, including:

A node classifying module, configured to classify nodes in the metropolitan optical network into multiple node sets based on locations of the nodes; and

A traffic prediction module, for nodes in each node set, configured to input temporal traffic data of the nodes into a traffic prediction model to obtain traffic prediction results of the nodes; where, the traffic prediction model is obtained by deep learning using historical time-series traffic data of the node sets as a training set.

For the convenience of description, the above devices can be divided into various modules based on their functions. Of course, the functions of each module can be implemented in the same or multiple software and/or hardware when implementing examples of the present disclosure.

The device of the above examples may be used to implement the corresponding traffic prediction method in any of the above examples, and has the beneficial effects of the corresponding methods, which will not be repeated here.

Examples of the present disclosure also provides an electronic device, which includes a memory, a processor, and a computer program stored in the memory and executable on the processor, the processor executes the program to implement the traffic prediction method.

FIG. 7 is a schematic diagram illustrating a structure of an electronic device according to some examples of the present disclosure. As shown in FIG. 7, the electronic device may include: a processor 1010, a memory 1020, an input/output interface 1030, a communication interface 1040, and a bus 1050. The processor 1010, the memory 1020, the input/output interface 1030, and the communication interface 1040 may couple to each other via the bus 1050.

The processor 1010 may execute the relevant procedures by virtue of a general central processing unit (CPU), a microprocessor, an application specific integrated circuit (ASIC), or one or more integrated circuits, so as to implement the technical solution provided by the examples of the description.

The memory 1020 may be implemented by a read only memory (ROM), a random-access memory (RAM), a static memory device and a dynamic memory device, etc. The memory 1020 may store an operating system and other application procedures. When the technical solution provided by the example of the description is implemented via the software or the hardware, the related procedure codes are stored in the memory 1020 and revoked by the processor 1010.

The I/O interface 1030 is used for connecting an I/O unit to realize information input and output. The I/O unit may be configured in the device (not in the figure) as a component configuration, and may be externally connected to the device to provide the corresponding functions. The input device may include keyboard, mouse, touch screen, microphone and various sensors. The output device may include display, loudspeaker, vibrator and indicator lamp.

A communication interface 1040 is used for connecting a communication unit (not shown in the figure) to realize communication interaction between the device and other devices. The communication unit may realize communication in a wired manner (for example, USB, wire, etc.) or in a wireless manner (for example, mobile network, WIFI, Bluetooth, etc.).

The bus 1050 includes a passage which transmits information among various components (for example, the processor 1010, the memory 1020, the I/O interface 1030 and the communication interface 1040) on the device.

It should be noted that, although the above-mentioned device merely shows the processor 1010, the memory 1020, the I/O interface 1030, the communication interface 1040 and the bus 1050, the device may further include other components required by the normal operation in the specific implementation process. Besides, those skilled in the art could appreciate that the above-mentioned device may merely include the components required by the solution in the examples of the Description, but not necessarily include all components shown in the figure.

The above-mentioned device of the present disclosure is used to realize the traffic prediction method in accordance with any of the above examples, and has the beneficial effects of the corresponding method, which will not be repeated here.

Based on a same inventive concept, examples of the present disclosure also provide a non-transitory computer-readable storage medium, which stores a computer instruction. The computer instruction is used to make a computer execute the traffic prediction method in accordance with any of the above examples.

The computer-readable storage medium in the example includes volatile, non-volatile, movable and non-movable media, which can realize information storage by any method or technology. The information can be computer readable instruction, data structure, program unit or other data. The example of computer storage media includes, but not limited to phase-change memory (PRAM), static random access memory (SRAM), dynamic random access memory (DRAM), other types of random access memory (RAM), read only memory (ROM), electrically erasable programmable read-only memory (EEPROM), flash memory or other memory technologies, compact disk read only memory (CD-ROM), digital versatile disc (DVD) or other optical memories, cassette magnetic tape, tape, disk memory or other magnetic memory device or any other non-transmission media, and available for storing information accessible by the computing devices.

Based on a same inventive concept of the traffic prediction method described in any of the above examples, the present disclosure also provides a computer program, which includes computer instructions. In some examples, the computer instructions may be executed by one or more processors of a computer to enable the computer and/or processor to execute the 1 traffic prediction method. Corresponding to the execution subject of each step in examples of the traffic prediction method, the processor executing the corresponding step can belong to the corresponding execution subject.

The computer program of the above example is used to enable the computer and/or processor to execute a traffic prediction method as described in any one of the above examples, and has the beneficial effects of corresponding methods, which will not be repeated here.

Those of ordinary skill in the art should appreciate that the discussion on any one of the foregoing examples is merely exemplary, but is not intended to imply that the scope of the present disclosure (including the claims) is limited to these examples. Under the idea of the present disclosure, the technical features of the foregoing examples or different examples may be combined, the steps may be implemented in any order, and there are many other variations in different aspects of the examples of the present disclosure, all of which are not provided in detail for simplicity.

Besides, for the sake of simplifying description and discussion and not making the examples of the present disclosure difficult to understand, the provided drawings may show or not show the public power supply/earthing connection to an integrated circuit (IC) chip and other parts. Besides, the device may be shown in block diagram form to prevent the examples of the present disclosure from being difficult, and moreover, this considers the following facts, that is, the details of the implementations with regard to the devices in these block diagrams highly depend on the platform which will implement the examples of the present disclosure (that is, these details should be completely within the scope understood by those skilled in the art). Where specific details (e.g. circuits) are set forth in order to describe exemplary examples of the present disclosure, it should be apparent to those skilled in the art that the examples of the present disclosure can be practiced without, or with variation of, these specific details. Therefore, these descriptions shall be considered to be illustrative instead of restrictive thereto. Therefore, these descriptions shall be considered to be illustrative instead of restrictive thereto.

While the present disclosure has been described in conjunction with specific examples thereof, many alternatives, modifications and variations of such examples will be apparent to those of ordinary skill in the art in light of the foregoing description. For example, other memory architectures, such as dynamic RAM (DRAM), may use the examples discussed.

The examples of the disclosure are intended to embrace all such alternatives, modifications, and variations as to fall within the broad scope of the appended claims. Therefore, any omission, modification, equivalent replacement and improvement made within the spirits and principles of the examples of the present disclosure shall fall within the protection scope of the present disclosure.

What is claimed is:

1. A traffic prediction method, comprising:
classifying nodes in a metropolitan optical network into multiple node sets based on locations of the nodes;
for nodes in each node set, inputting temporal traffic data of the nodes into a traffic prediction model corresponding to the node set to obtain traffic prediction results of the nodes in the node set;
wherein, the traffic prediction model is obtained by a deep learning using historical time-series traffic data of the node set as a training set.

2. The traffic prediction method according to claim 1, wherein, classifying nodes in the metropolitan optical network into multiple node sets based on locations of the nodes comprises:
obtaining bandwidth demand data of the nodes in the metropolitan optical network;
classifying the nodes into at least two types based on the bandwidth demand data of the nodes; and
grouping adjacent nodes of a same type into a node set to obtain the multiple node sets.

3. The traffic prediction method according to claim 1, wherein, the historical time-series traffic data of the node sets is obtained through the following steps:
obtaining the bandwidth demand data of nodes comprised in a node set;
segmenting the bandwidth demand data according to a preset time interval to obtain bandwidth demand data of multiple time periods;
processing the bandwidth demand data of the multiple time periods to obtain multiple rate data; and
storing the multiple rate data and corresponding time periods to obtain the historical time-series traffic data.

4. The traffic prediction method according to claim 3, wherein, the rate data comprises: an average rate, a maximum rate, a minimum rate, a first quartile rate, a second quartile rate, and a third quartile rate.

5. The traffic prediction method according to claim 1, wherein, a neural network used for the deep learning comprises: any of a recurrent neural network, a bidirectional recurrent neural network, a long short-term memory network, and a bidirectional long short-term memory recurrent network.

6. The traffic prediction method according to claim 1, wherein, after obtaining the traffic prediction results of the nodes, the method further comprises: determining bandwidths of the nodes based on the traffic prediction results of the nodes.

7. The traffic prediction method according to claim 6, wherein, after determining the bandwidths of the nodes, the method further comprises:
determining a source node and a target node for data transmission according to a service request from the source node to the target node; and
determining a modulation format for data transmission based on a distance between the source node and the target node as well as a bandwidth request of the service request.

8. The traffic prediction method according to claim 7, wherein, determining a modulation format for data transmission based on a distance between the source node and the target node as well as a bandwidth request of the service request comprises:
determining a shortest path from the source node to the destination node;
determining a transmission distance of the shortest path;
selecting an optimal modulation format according to the transmission distance of the shortest path based on relationships between transmission distance ranges and modulation levels; and
calculating required number of frequency slots for the service request according to the optimal modulation format and the bandwidth request of the service request.

9. An electronic device, comprising a memory, a processor, and a computer program stored in the memory and executable on the processor, wherein the processor executes the computer program to implement the method according to claim 1.

10. A non-transitory computer-readable storage medium, which stores computer instructions for causing a computer to execute the traffic prediction method according to claim 1.
